(19) United States
(12) Patent Application Publication
(10) Pub. No.: US 2013/0160993 A1
(43) Pub. Date: Jun. 27, 2013

(54) WEDGE RING FOR ATTACHING CENTRALIZERS

(71) Applicants: Juan Francisco Davila, Cypress, TX (US); Colin Joseph Lewis, Houston, TX (US)

(72) Inventors: Juan Francisco Davila, Cypress, TX (US); Colin Joseph Lewis, Houston, TX (US)

(73) Assignee: TESCO CORPORATION, Houston, TX (US)

(21) Appl. No.: 13/333,809

(22) Filed: Dec. 21, 2011

(51) Int. Cl. E21B 17/10; F16L 15/04

(52) U.S. Cl. 166/241.6; 285/333

(57) ABSTRACT

A wedge ring is provided for securing a centralizer or other structure to a tubular element. The wedge ring comprises a first surface comprising a plurality of teeth configured to engage a surface of the tubular element. The wedge ring also comprises a second surface that is threaded to engage a complementary threaded surface of the centralizer or other structure.

### FIELD OF DISCLOSURE

The present disclosure relates generally to the field of well drilling operations. More specifically, embodiments of the present disclosure relate to the use of centralizers with casing or tubing in a down-hole environment and the attachment of such centralizers, or other structures to the casing or tubing.

### BACKGROUND

In conventional oil and gas operations, a well is typically drilled to a desired depth with a drill string, which includes drill pipe and a drilling bottom hole assembly (BHA). Once the desired depth is reached, the drill string is removed from the hole and casing is run into the vacant hole. In some conventional operations, the casing may be installed as part of the drilling process. A technique that involves running casing at the same time the well is being drilled may be referred to as “casing-while-drilling.”

Casing may be defined as pipe or tubular that is placed in a well to prevent the well from caving in, to contain fluids, and to assist with efficient extraction of product. When the casing is properly positioned within a hole or well, the casing is typically cemented in place by pumping cement through the casing and into an annulus formed between the casing and the hole (e.g., a wellbore or parent casing). Once a casing string has been positioned and cemented in place or installed, the process may be repeated via the now installed casing string. For example, the well may be drilled further by passing a drilling BHA through the installed casing string and drilling. Further, additional casing strings may be subsequently passed through the installed casing string (during or after drilling) for installation. Indeed, numerous levels of casing may be employed in a well. For example, once a first string of casing is in place, the well may be drilled further and another string of casing (an inner string of casing) with an outside diameter that is accommodated by the inside diameter of the previously installed casing may be run through the existing casing. Additional strings of casing may be added in this manner such that numerous concentric strings of casing are positioned in the well, and such that each inner string of casing extends deeper than the previously installed casing or parent casing string.

Liner may also be employed in some drilling operations. Liner may be defined as a string of pipe or tubular that is used to case open hole below existing casing. Casing is generally considered to extend all the way back to a wellhead assembly at the surface. In contrast, a liner merely extends a certain distance (e.g., 30 meters) into the previously installed casing or parent casing string. However, a tieback string of casing may be installed that extends from the wellhead downward into engagement with previously installed liner. The liner is typically secured to the parent casing string by a liner hanger that is coupled to the liner and engages with the interior of the upper casing or liner. The liner hanger may include a slip device (e.g., a device with teeth or other gripping features) that engages the interior of the upper casing string to hold the liner in place. It should be noted that, in some operations, a liner may extend from a previously installed liner or parent liner. Again, the distinction between casing and liner is that casing generally extends all the way to the wellhead and liner only extends to a parent casing or liner. Accordingly, the terms “casing” and “liner” may be used interchangeably in the present disclosure. Indeed, liner is essentially made up of similar components (e.g., strings of tubular structures) as casing. Further, as with casing, a liner is typically cemented into the well.

Thus, establishing a down-hole operation, such as may be involved in conventional oil and gas operations, may involve deploying and operating a variety of tubular components (e.g., casing, liner, drill pipe, and so forth) down a tubular wellbore while the wellbore is being formed or after the wellbore is formed. In certain instances, the tubular elements may be fitted with a component that acts to centralize the tubular elements within the bore, e.g., a centralizer. For example, during a casing drilling operation, a series of centralizers may be fitted to the casing during the drilling operation to keep the casing centered within the bore. For example, the centralizers may be fitted at the joints where casing segments are joined (such as every 30 feet) or at other periodic distances to insure that the casing remains centered in the bore.

In certain conventional approaches the centralizer element may float free of the tubular element it surrounds, i.e., the centralizer is not attached to the underlying casing or pipe and does not rotate with the casing or pipe during drilling. In other instances, the centralizers are attached to the casing (or other tubular element) via a crimping or friction fit operation. However, such attachment operations require heavy equipment and are labor intensive. Further, overpressurization or underpressurization during the fitting operations may occur, leading to damage to the casing or centralizer and/or an unsuitable fit. In addition, the attachment of the centralizers is typically done at the drilling site, meaning the needed equipment must be transported to the site and subsequently removed. Therefore, it may be desirable to improve the manner in which centralizing elements are attached to tubular components used in a down-hole environment.

### BRIEF DESCRIPTION

In accordance with one aspect of the invention, a wedge ring is provided. The wedge ring comprises an annular body having a tapered profile sized to fit around a tubular element. The wedge ring also comprises a first surface of the annular body, wherein the first surface comprises a plurality of teeth configured to grip an outer surface of the tubular element. In addition, the wedge ring comprises a second surface of the annular body, wherein the second surface comprises spiral threading.

In accordance with another aspect of the invention, an assembly is provided. The assembly comprises a casing or liner string and a centralizer configured to fit around a circumference of the casing or liner string. The assembly comprises a first wedge ring positioned between an inner surface of a first end of the centralizer and an outer surface of the casing or liner string.

In accordance with another aspect of the invention, a centralizer is provided. The centralizer comprises a tubular body and one or more raised features projecting outward from the tubular body. The centralizer also comprises a first end comprising a first inner surface threaded in a first direction. The centralizer also comprises a second end comprising a second inner surface threaded in a second direction opposite the first direction.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a well being drilled in accordance with aspects of the present disclosure;

FIG. 2 is a partial cut-away view of a centralizer attached to a casing or liner using wedge rings, in accordance with aspects of the present disclosure;

FIG. 3 depicts a partial sectional view through a wedge ring, in accordance with aspects of the present disclosure;

FIG. 4 depicts an external side of a wedge ring, in accordance with aspects of the present disclosure;

FIG. 5 is a partial cut-away view of a wedge ring and centralizer end region in which the wedge ring is shown projecting further outward than the centralizer end region, in accordance with aspects of the present disclosure;

FIG. 6 is a partial cut-away view of a wedge ring and centralizer end region, in accordance with aspects of the present disclosure; and

FIG. 7 depicts schematically an example of a tooth of a wedge ring, in accordance with aspects of the present disclosure.

### DETAILED DESCRIPTION

The present disclosure relates generally to the attachment of a centralizer (or other structure) to a down-hole component, such as a casing, liner, or drill pipe. Embodiments of the present disclosure are directed to providing and using wedge rings for attachment of a centralizer to a tubular component. In one implementation, an annular (i.e., ring-shaped) wedge ring for attaching a centralizer is spirally threaded on one surface to mate with complementary spiral threading on an end of the centralizer. The wedge ring has a second surface that has teeth or ridges for gripping a surface of the tubular element (e.g., casing) to which the centralizer is being attached. In such an implementation, a wedge ring may be positioned at each end of the centralizer to be attached, and, as the centralizer is rotated and engages the complementary spiral threading of the wedge rings, the wedge rings will be pulled inward toward the centralizer, engaging both the centralizer and underlying tubular element so as to attach the centralizer to the underlying tubular element.

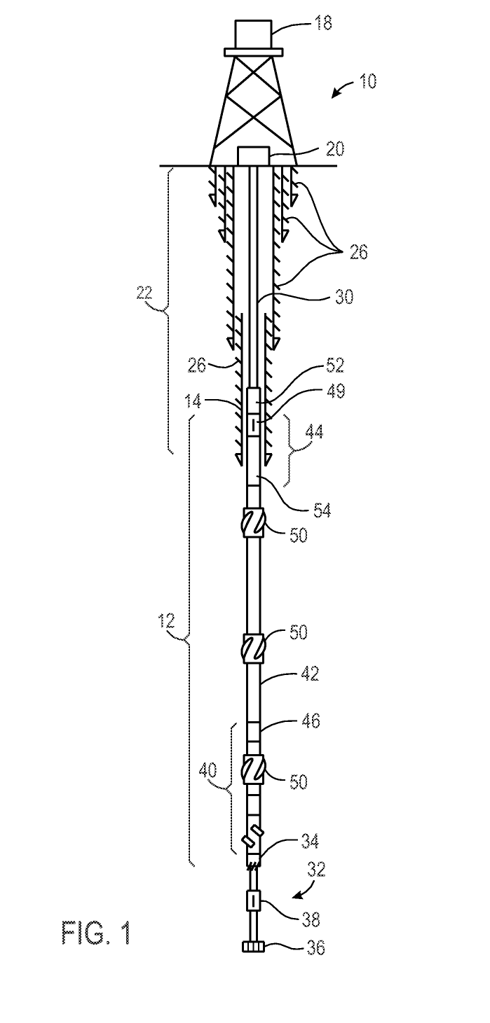

With the foregoing in mind, and turning to the figures, FIG. 1 is a schematic representation of a well 10 that is being drilled using a casing-while-drilling technique, wherein a liner string 12 is about to be hung within a previously installed liner 14 that was cemented into the well 10. In other embodiments, different drilling techniques may be employed. The well 10 includes a derrick 18, wellhead equipment 20, and several levels of casing 22 (e.g., conductor pipe, surface pipe, intermediate string, and so forth), which includes the previously installed liner 14, which may be casing in some embodiments. The casing 22 and the liner 14 have been cemented into the well 10 with cement 26. Further, as illustrated in FIG. 1, the liner string 12 is in the process of being hung from the previously installed liner 14, which may be referred to as the parent liner 14.

While other embodiments may utilize different drilling techniques, as indicated above, the well 10 is being drilled using a casing-while-drilling technique. Specifically, the liner string 12 is being run as part of the drilling process. In the illustrated embodiment, a drill pipe 30 is coupled with the liner string 12 and a drilling BHA 32. The drilling BHA 32 is also coupled with an upper portion of the liner string 12 and extends through the liner string 12 such that certain features of the drilling BHA 32 extend out of the bottom of the liner string 12. Indeed, an upper portion of the drilling BHA 32 is disposed within the inside diameter of the liner string 12, while a lower portion of the drilling BHA 32 extends out of a liner shoe 34 at the bottom of the liner string 12. Specifically, in the illustrated embodiment, a drill bit 36 and an under reamer 38 of the drilling BHA 32 extend out from the liner string 12. Thus, the drilling BHA 32 is positioned to initiate and guide the drilling process.

The liner string 12 includes a shoe track 40, a string of tubing 42, and a liner top assembly 44. The shoe track 40 defines the bottom of the liner string 12 and includes the liner shoe 34 to facilitate guiding the liner string 12 through the wellbore. In the illustrated embodiment, the shoe track 40 also includes an indicator landing sub 46 to facilitate proper engagement with the drilling BHA 32, and various other features, such as a pump down displacement plug (PDDP). The string of tubing 42 is essentially the main body of the liner string 12 that connects the shoe track 40 with the liner top assembly 44. The liner top assembly 44, which defines the top of the liner string 12, includes a liner hanger 49 that is capable of being activated and/or deactivated by a liner hanger control tool 52. The liner top assembly 44 may also include a liner drill lock section 54, which includes a liner drill lock that facilitates engagement/disengagement of the drill string 30 from the liner string 12. The liner drill lock may be actuated by external or internal components affixed to or part of a body of the liner hanger 49.

Once a desired depth is reached, the liner string 12 may be hung or set down to facilitate detachment of the drilling BHA 32. As illustrated in FIG. 1, the liner string 12 may be hung from the parent liner 14, and the drilling BHA 32 may be detached from the liner string 12 and pulled out of the well 10 with the drill string 30 and an inner string (not shown). In order to hang the liner string 12 from the parent liner 14, the hanger 49 may be activated with the liner hanger control tool 52. In some embodiments, the hanger 49 is not utilized and the liner string 12 is set on bottom.

The casing and liner strings (e.g., the casing 22, the parent liner 14, and the liner string 12) are run into the well 10 using a running tool. As used herein, the terms “casing” and “liner” may be used interchangeably in the present disclosure. As will be appreciated from this discussion, a wide array of tubular elements (e.g., casing, liner, drill pipe, and so forth) may be positioned within the wellbore. For example, in the above described implementation of casing-while-drilling, casing or liner string 12 may be positioned in the well bore as part of the drilling or deployment operation. For instance, in one type of implementation, the casing may consist of 30 foot segments of a suitable diameter (e.g., 13⅜ inches) that are joined as the casing is deployed down the wellbore. As will be appreciated, in other implementations, length of the casing segments and/or the diameter of the casing may be any suitable length or diameter.

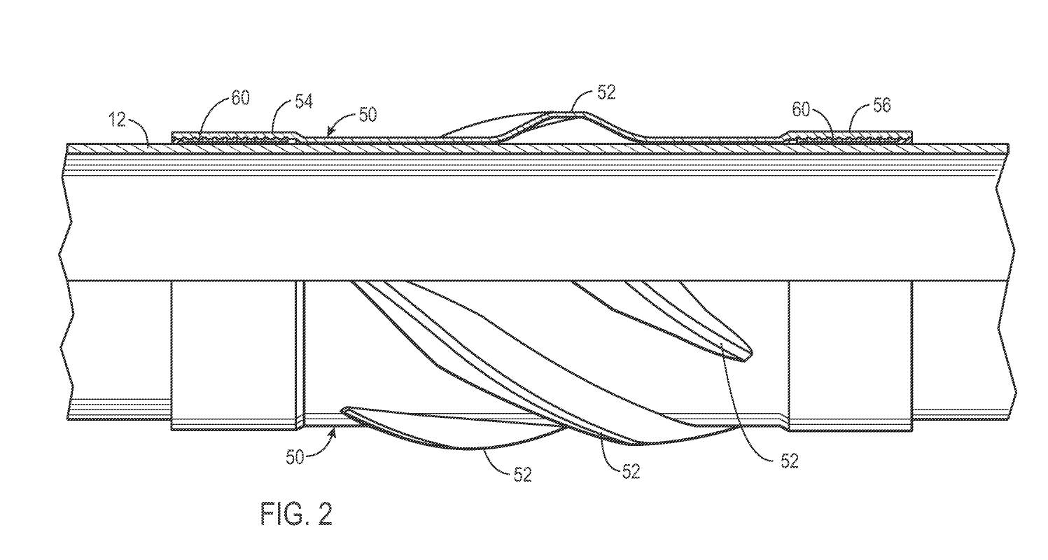

As discussed herein, some of the various tubular elements, such as the casing, may have one or more centralizing elements (i.e., centralizers 50) attached that keep the tubular element centered within the wellbore when deployed and operated (e.g., rotated). Turning to FIG. 2, one example of a centralizer 50 disposed about a casing or liner string 12 is depicted in a partial cut-away view. In this example, the centralizer 50 has raised features 52 disposed circumferentially about the centralizer 50 which act to keep the casing or liner string 12 centered within the wellbore. In one implementation, the walls of the centralizer 50 are ½ inch thick, though in other implementations the walls of the centralizer 50 may be any suitable thickness. In addition, the centralizer 50 includes a first end 54 and a second end 56 that are each spirally threaded on an interior diameter to complement the spiral threading on the outer diameter of respective wedge rings 60, discussed herein. In one implementation, the spiral threading of the first end 54 and the second end 56 are opposite of one another (e.g., the first end 54 has a left-handed threading and the second end 56 has a right-handed threading, or vice versa) so that rotating the centralizer 50 in one direction will draw both respective wedge rings 60 inward toward the centralizer 50. That is, due to the opposing spiral threading of the first end 54 and second end 56, in such an implementation, and the complementary threading of the respective wedge rings 60, spinning or rotating the centralizer 50, such as with a chain wrench, acts to draw in and tighten the wedge rings 60.

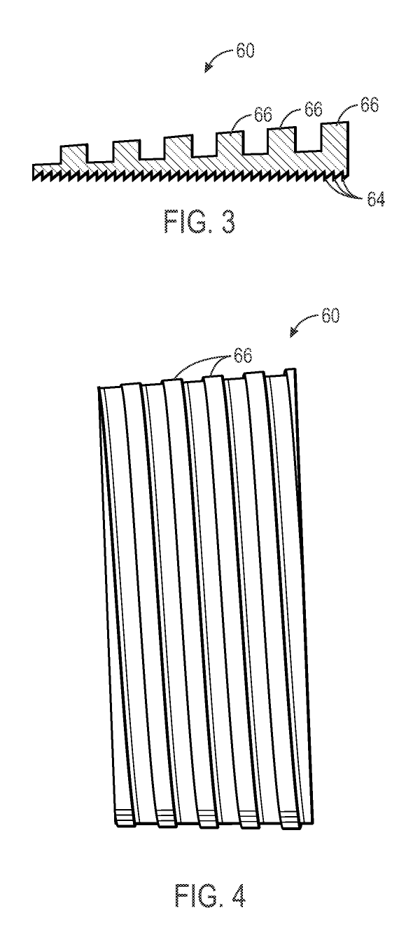

By way of example, and to provide additional detail with respect to one implementation of an annular wedge ring 60, FIGS. 3 and 4 depict respectively, a sectional view through a wedge ring 60 and an external side view of a wedge ring 60. In one embodiment, the wedge ring 60 is about 6 inches long, though in other implementations the wedge ring 60 may be any suitable length. As depicted in FIG. 3, the wedge ring 60 has a tapered profile and includes, on an inner surface, a series of teeth 64 that facilitate gripping of a casing or liner string 12 when the wedge ring 60 is used in conjunction with a centralizer 50. On the outer surface of the wedge ring 60, the surface is threaded (i.e., with wedge ring threads 66) in a complementary manner to the threading present on a mating surface of a centralizer 50. The wedge ring threading 66 is also depicted in the external side view of the wedge ring 60 provided by FIG. 4.

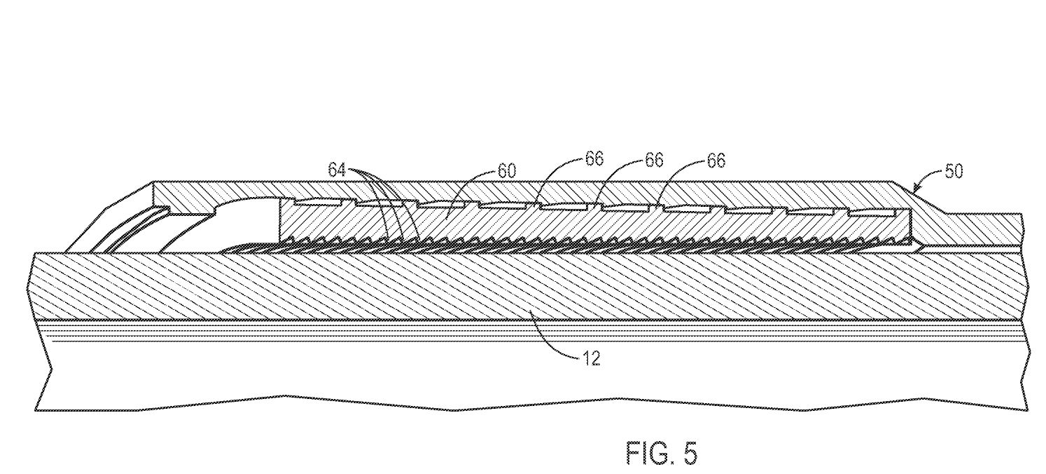

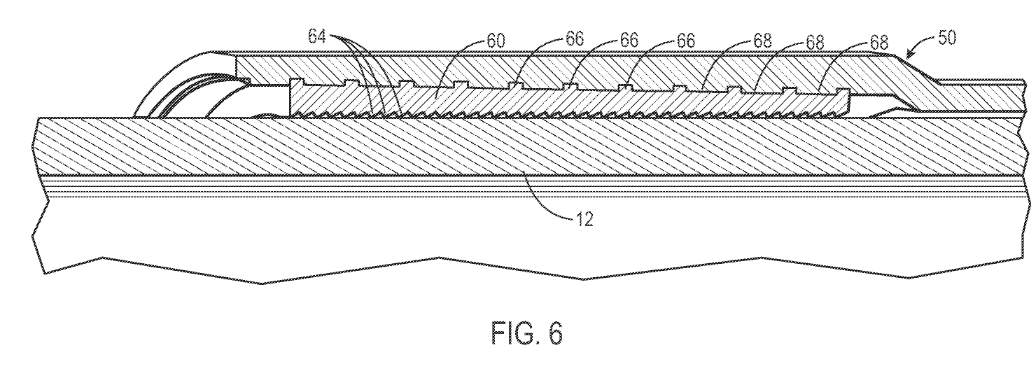

To better illustrate the engagement of a wedge ring 60 and centralizer 50, FIGS. 5 and 6 depict close-up perspective cut-away views of a wedge ring 60 in combination with a centralizer 50 and a casing or liner string 12. In FIG. 5, the wedge ring 60 is shown projecting further out from the centralizer 50 to better depict the teeth 64 and wedge ring threads 66 of the wedge ring 60. As depicted in FIGS. 5 and 6 the wedge ring 60 is sized to slide inward under the respective end of the centralizer 50 as the complementary centralizer threads 68 and wedge ring threads 66 engage, such as upon rotation of the centralizer 50 in the appropriate direction.

Due to the wedge-shape of the wedge ring 60 (as depicted in FIG. 3), as the wedge ring 60 is drawn under the centralizer 50, a downward force is applied to the casing or liner string 12, causing the teeth 64 to bite into the casing, thereby securing the centralizer 50 in place. Further, in the depicted implementation, the teeth 64 are angled so as to allow movement of the wedge ring 60 inward toward the centralizer 50 as the centralizer 50 is rotated, but to resist movement of the wedge ring 60 outward afterwards. That is, once in place, the wedge ring 60 grips the underlying casing or liner string 12.

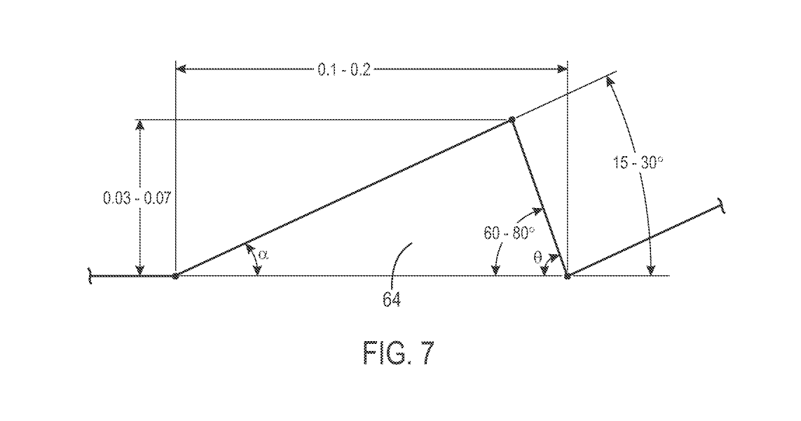

In one implementation, the teeth 64 may be carburized teeth and may be suitably dimensioned so as to facilitate cutting into and/or gripping the casing or liner string 12 when the wedge ring 60 is in place. For example, turning to FIG. 7, in one implementation, each tooth 64 may be about 0.03 inches to about 0.07 inches in height (such as 1/16th of an inch) and about 0.1 inches to about 0.2 inches in length. In one embodiment, an angle α associated with each tooth 64 may be about 15° to about 30° while an angle θ may be about 60° to about 80°. As will be appreciated the examples of measurements and angular ranges provided herein are not intended to be limiting and instead merely provided examples of suitable dimensions and/or angles. Other dimensions and/or angles may also be suitable and are encompassed by the present disclosure.

While the preceding discussion has generally related to the application of a centralizer 50 to a casing or liner string 12 using wedge rings 60, it should be appreciated that this implementation has been provided by way of example only, and is not intended to limit the scope of the present disclosure. That is, the use of wedge rings 60 as disclosed herein may be similarly applied to attach other elements or structures to a tubular element. For example, wedge rings 60 as disclosed herein may be used to apply wear bands or other structures to a casing or liner string 12 or to any other suitable tubular element. With the foregoing discussion in mind, it should be appreciated that certain presently described embodiments allow engagement of a structure, such as a centralizer or wear band, to a tubular element, such as a casing or liner string by the use of wedge rings as discussed herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A wedge ring, comprising:
an annular body having a tapered profile sized to fit around a tubular element;
a first surface of the annular body, wherein the first surface comprises a plurality of teeth configured to grip an outer surface of the tubular element;
a second surface of the annular body, wherein the second surface comprises spiral threading.

2. The wedge ring of claim 1, wherein the annular body approximately 6 inches long.

3. The wedge ring of claim 1, wherein the spiral threading is configured to mate with complementary threading of a centralizer structure configured to fit around a circumference of the tubular element.

4. The wedge ring of claim 1, wherein the tubular element comprises a casing, a liner string, or a drill pipe.

5. The wedge ring of claim 1, wherein the plurality of teeth comprise carburized teeth.

6. The wedge ring of claim 1, wherein each tooth is about 0.03 inches to about 0.07 inches in height.

7. The wedge ring of claim 1, wherein each tooth is about 0.1 inches to about 0.2 inches in length.

8. A assembly, comprising:
a casing or liner string;
a centralizer configured to fit around a circumference of the casing or liner string, the centralizer comprising at least a first end; and
a first wedge ring positioned between an inner surface of the first end of the centralizer and an outer surface of the casing or liner string.

9. The assembly of claim 8, wherein the first wedge ring is in threaded engagement with the inner surface of the first end of the centralizer.

10. The assembly of claim 8, wherein the first wedge ring comprises a plurality of teeth in engagement with the outer surface of the casing or liner string.

11. The assembly of claim 10, comprising:
a second wedge ring positioned between a second end of the centralizer and the casing or liner string.

12. The assembly of claim 11, wherein the first end of the centralizer and the second end of the centralizer, respectively, comprise oppositely threaded surfaces such that rotation of the centralizer in a first direction causes movement of both the first wedge ring and the second wedge ring inward with respect to the centralizer.

13. The assembly of claim 11, wherein the wedge ring comprises a tapered profile such that when positioned between the inner surface of the first end of the centralizer and the outer surface of the casing or liner string, a downward pressure is exerted on the outer surface of the casing or liner string.

14. A centralizer, comprising:
a tubular body;
one or more raised features projecting outward from the tubular body;
a first end comprising a first inner surface threaded in a first direction; and
a second end comprising a second inner surface threaded in a second direction opposite the first direction.

15. The centralizer of claim 14, wherein the tubular body is configured to fit around a circumference of a casing or liner string.

16. The centralizer of claim 14, wherein the first end is configured to engage a first complementary threaded surface of a first wedge ring and the second end is configured to engage a second complementary threaded surface of a second wedge ring.

17. The centralizer of claim 16, wherein rotation of the centralizer in a first direction causes movement of the first wedge ring and the second wedge ring toward one another.

18. The centralizer of claim 17, wherein the movement of the first wedge ring and the second wedge ring toward one another concurrently causes downward pressure on an outer surface of a casing or liner string.

19. The centralizer of claim 18, wherein the downward pressure on the outer surface of the casing or liner string results in respective teeth on the first wedge ring and on the second wedge ring cutting into or otherwise gripping the outer surface of the casing or liner string.

20. The centralizer of claim 19, wherein the centralizer is secured to the casing or liner string by the first wedge ring and the second wedge ring.
